(19) United States
(12) Patent Application Publication
(10) Pub. No.: US 2002/0122858 A1
(43) Pub. Date: Sep. 5, 2002

(54) Method for making a filled bagel

(76) Inventor: Lawrence S. Baras, Brookline, MA (US)

Correspondence Address: PERKINS, SMITH & COHEN LLP, ONE BEACON STREET, 30TH FLOOR, BOSTON, MA, 02108, US

(21) Appl. No.: 09/797,014

(22) Filed: Mar. 1, 2001

(51) Int. Cl. A21D 6/00

(52) U.S. Cl. 426/496

(57) ABSTRACT

Low moisture absorption flour and a direct set cream cheese are used to make a filled bagel. The torus is formed by first co-extruding the cream cheese and dough to form a cream cheese-filled tube of dough, and then by cutting the dough and the ends of the cut pieces. The formed dough is the proofed, steamed and baked. The bagels are removed from the oven and immediately frozen in order to form a filled bagel with a minimum of cavitation.

### FIELD OF THE INVENTION

This invention relates generally to a process for making a filled dough product and more particularly to a process for making a filled, toroidally-shaped bagel.

### BACKGROUND OF THE INVENTION

A bagel is a piece of baked yeast dough which is substantially shaped like a torus. The traditional method for making a bagel involves kneading the dough, allowing it to rise, forming the dough into a toroidal shape, boiling the formed dough to create a skin, and then baking the dough. Alternatively, a skin may be created by omitting the boiling step and adding steam to the baking step. A common spread for bagels is cream cheese, which is a soft, unripened cheese made from cow's milk. Bagels with cream cheese are a common “quick” breakfast food. In order to make a bagel that is more convenient to the consumer, it is desirable to have a bagel that is already filled with cream cheese.

Methods for making filled food products exist. One method is to inject the filling into an already-baked dough product. These products, however, have not been toroidal in shape. Alternative methods which produce a filled product that is toroidal in shape have yielded bagels that are unsatisfactory in texture or taste.

It is an object of the present invention to provide a method of making a filled bagel that is toroidal in shape.

### SUMMARY OF THE INVENTION

The problems of making a filled toroidal bagel are solved by the present invention.

Low moisture absorption flour and a direct set cream cheese are used to make a filled bagel. The torus is formed by first co-extruding the cream cheese and dough to form a cream cheese-filled tube of dough, and then by cutting the dough and connecting the ends of the cut pieces. The formed dough is the proofed, steamed and baked. The bagels are removed from the oven and immediately frozen in order to form a filled bagel with a minimum of cavitation.

The present invention together with the above and other advantages may best be understood from the following detailed description of the embodiments of the invention illustrated in the drawings, wherein:

### BRIEF DESCRIPTION OF THE DRAWINGS

FIG. 1 is a flow chart of the process of making a bagel according to principles of the invention; and

FIG. 2 is a pictorial diagram of a filled bagel according to the principles of the invention.

### DETAILED DESCRIPTION OF PREFERRED EMBODIMENTS

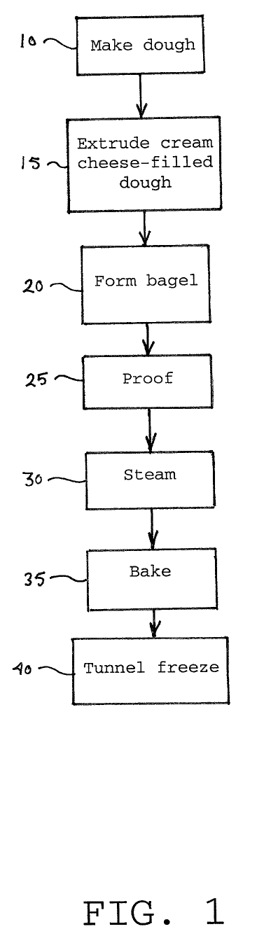

FIG. 1 is a flow chart of the bagel manufacturing process. First the dough is made, block 10. In a preferred embodiment of the invention, enriched flour with low moisture absorption is used. The flour has the following components: bleached wheat flour; malted barley flour having Niacin, iron, thiamin, mononitrate, riboflavin, potassium bromide, dactyl tartaric acid, esters of mono and diglycerides, L-cysteine hydrochloride, ascorbic acid, fungal proteinase, acodicarbonamide; sugar; salt; 2% molasses; Mono-Diglycerides; Ascorbic Acid; L-Cystein; Azodicarbonamide enzyme; and Ammonium chloride. The invention is not limited to this flour. Other low moisture absorption flours may also be used.

Water is added to the flour to make a dough that is approximately 36% water by weight. The temperature of the water is approximately 80-85 degrees Fahrenheit so that the dough temperature is 80-85 degrees Fahrenheit during mixing. Yeast is also added to the mixture, approximately 0.006% by weight.

The dough is mixed in a spiral mixer, first two minutes on slow speed, then 5 minutes on high speed to make the dough smooth and elastic.

Next, cream cheese filled dough is extruded, block 15. The mixed dough is put into a first hopper in a co-extrusion machine. In the present embodiment of the invention the coextrusion machine is a Rheon machine. Cream cheese is put into a second hopper of the co-extrusion machine. The cream cheese is a “direct set” cream cheese. Standard cream cheese defined by the Food and Drug Administration (FDA) as containing at least 33 percent milk fat and not more than 55 percent moisture. Direct set cream cheese has a lower moisture content than standard cream cheese.

The co-extrusion machine extrudes a tube of dough filled with cream cheese. The dough is cut and formed into a cream cheese filled tube of dough, and the ends of each piece are connected to form a toroidal bagel shape, block 20.

The formed dough is put on perforated baking pans and then proofed, block 25. The proofing step involves putting the pans into a high humidity, 100 degree chamber for 45 minutes. Proofing enables the dough to rise. Proofing temperatures are, for example, 90-100° F. and proofing times are, for example, 45 minutes to one hour.

The bagels are then steamed for approximately 20 seconds, block 30. The steam creates a shine on the exterior of the bagel.

The bagels are then baked at high temperature for approximately eight minutes, block 35. In the present invention, the temperature is 535° F.

After baking, the bagels are frozen. In the present embodiment of the invention, the bagels are frozen in a multi-chamber cryogenic tunnel freezer, block 40. The tunnel freezer brings the bagels from the oven where the temperature is approximately 530 F. to minus 450 degrees. The bagel emerges frozen from the tunnel freezer. In alternative embodiments of the invention, other types of freezers and freezing processes are possible. The bagels may for example be placed inside a freezer unit.

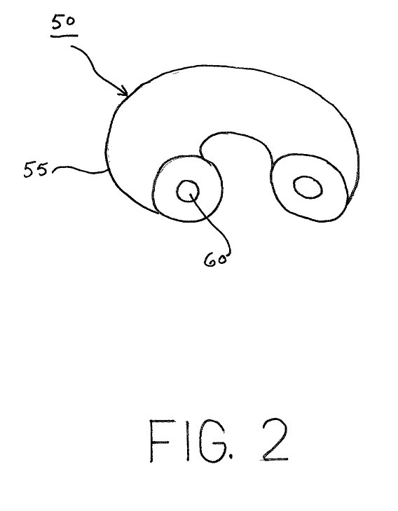

FIG. 2 is a pictorial diagram of a bagel manufactured according to principles of the present invention. The bagel 50 is toroidally-shaped. The breaded portion 55 is filled with cream cheese 60.

The low absorption flour is important in reducing cavitation inside the bagel. Cavitation is a space between the filling and the bread inside the filled bagel. Cavitation occurs when the bagel dough absorbs moisture from the cream cheese. This occurs if the flour is aborbant and this also occurs if the cream cheese has high moisture content. Cavitation is undesirable because it makes an unattractive product.

Another cause of cavitation is steaming from the cream cheese. During the time that the internal bagel temperature exceeds the boiling point of the cream cheese boiling point (which is approximately 200° F.), the cream cheese begins to evaporate. The cream cheese steam pushes up on the dough above it causing a cavity because the steam cannot escape the dough. Baking at a higher than average temperature for a shorter period of time reduces cavitation. Reducing the cooling period also reduces cavitation because the cream cheese continues to steam during the cooling period. Using lower moisture direct set cream cheese also reduces cavitation.

In alternate embodiments of the invention, other fillings, such as fruit fillings, may be used. Also in other embodiments of the invention, flavored cream cheeses or cream cheeses with added ingredients, such as vegetables, may be used. Alternate embodiments further include egg fillings, meat fillings, cheese, lox cream cheese and peanut butter and jelly.

It is to be understood that the above-described embodiments are simply illustrative of the principles of the invention. Various and other modifications and changes may be made by those skilled in the art which will embody the principles of the invention and fall within the spirit and scope thereof.

What is claimed is:

1. A process for making a filled, toroidally-shaped bagel, comprising the steps of:
a) forming a quantity of dough;
b) co-extruding said dough and cream cheese to make a cream cheese-filled tube of dough;
c) cutting a length of said co-extruded tube;
d) forming a toroidally-shaped bagel by joining the ends of said length together;
e) proofing said bagel;
f) steaming said proofed bagel; and,
g) baking said steamed bagel.

2. The process of claim 1 wherein said dough further comprises a low moisture absorbing flour.

3. The process of claim 1 wherein said cream cheese is a low moisture cream cheese.

4. The process of claim 1 wherein said cream cheese is a direct set cream cheese.

5. The process of claim 1 wherein the baking step comprises baking said bagel at 535 F.

6. The process of claim 1 further comprising the step of:
h) freezing said bagel.

7. The process of claim 6 wherein said freezing step further comprises freezing said bagel in a tunnel freezer.
